(19) United States
(12) Patent Application Publication
(10) Pub. No.: US 2014/0292793 A1
(43) Pub. Date: Oct. 2, 2014

(54) IMAGE PROCESSING METHOD AND IMAGE DISPLAY DEVICE

(71) Applicants: QISDA CORPORATION, Taoyuan County (TW); QISDA (SUZHOU) CO., Ltd., Suzhou (CN)

(72) Inventors: Yu-Ting Lai, Changhua County (TW); Fang-Bin Liu, Hsinchu City (TW)

(73) Assignees: QISDA CORPORATION, Taoyuan County (TW); QISDA (SUZHOU) CO., Ltd., Suzhou (CN)

(21) Appl. No.: 14/242,880

(22) Filed: Apr. 2, 2014

(30) Foreign Application Priority Data
Apr. 2, 2013 (TW) 102111972

(51) Int. Cl. G09G 5/10

(52) U.S. Cl. CPC G09G 5/10
USPC 345/589

(57) ABSTRACT

The invention discloses an image display device and an image processing method thereof. The image display device includes a processing module and a screen electrically connected to the processing module. The processing module receives a series of digital signals and displays an image frame on the screen based on a first signal—gray level relation. An image block is selected from the image frame. The series of digital signals and a subset of digital signals corresponding to the image block correspond to a first and a second gray level ranges, respectively. The first gray level range covers the second gray level range. The processing module generates a second signal—gray level relation based on the second gray level range and re-displays the image block on the screen based on the subset of digital signals and the second signal—gray level relation, so as to enhance the gray level resolution of the image block.

### BACKGROUND OF THE INVENTION

1. Field of the Invention

The present invention relates to an image processing method and an image display device, and more particularly, to an image processing method and an image display device capable of re-displaying an image block.

2. Description of the Prior Art

In the current ultrasound image display system, the echo waves of the detected object are presented in the form of analog signals. To facilitate the signal processing of the consequent electronic devices, the analog signals will be transformed into digital signals, and these digital signals still include plenty of information about the structure of the object. Due to the resolution of the display device, the current display device is not able to display all the details of the structure. Aforementioned digital signals normally are further transformed into gray level signals suitable for the resolution of the display device to be the input signals of the display device. Generally speaking, to take into consideration both the resolution of the display device and the visual characteristics of the human eyes, the aforementioned transformation of the gray level signals are generally based on log compression. The gray level signals after transformation are to be display as an image by the display device, and the image is used as a rough delineation of the characteristics of the object structure. After aforementioned log compression, however, the information of the structure characteristics included in the gray level signals after transformation is obviously less than what is included in the original digital signals. When a user needs to further review a specific region of the image, the current ultrasound image display system generally can only display an enlarged image of the specific region based on the gray level signals of that region, but can not provide more detailed structure characteristics of the object.

### SUMMARY OF THE INVENTION

Due to the problems stated in the description of the prior art, one purpose of the present invention is to provide an image processing method in which based on an image block selected from an image frame, new gray level signals are generated to be re-displayed so that the image block with enhanced gray level resolution is provided to the user. When the invention is applied to the ultrasound image display system, it resolves the problems of the prior art that can not provide the image with more detailed structure characteristics of the object.

The image processing method of the invention is applied to re-display an image block selected from an image frame. The image frame is display based on a series of digital signals and a first signal—gray level relation. The image processing method comprises the steps of: Extracting a subset of digital signals for displaying the image block from the series of digital signals, wherein based on the first signal—gray level relation the series of digital signals and the subset of digital signals correspond to a first and a second gray level ranges, respectively;. generating a second signal—gray level relation based on the second gray level range; and re-displaying the image block based on the subset of digital signals and the second signal—gray level relation. Thus, according to the image processing method of the invention, the image block is re-displayed based on the original digital signals, i.e. the subset of digital signals extracted from the series of the digital signals, and the new signal—gray level relation, i.e. the second signal—gray level relation, so that the re-displayed image block includes plenty of detailed image information. In other words, no matter the image block is re-displayed in the original size or the enlarged size, the re-displayed image block provides more image details than the original image block does.

Another purpose of the invention is to provide an image display device in which the image processing method of the invention is applied to re-display a specific image block so that the image block with enhanced gray level resolution is provided. It thus resolves the problems of the prior art that can not provide the image with more detailed structure characteristics of the object.

The image display device of the invention comprises a screen and a processing module. The processing module is electrically connected to the screen. The processing module receives a series of digital signals and displays an image frame on the screen based on a first signal—gray level relation. The series of digital signals corresponds to a first gray level range based on the first signal—gray level relation. The processing module extracts from the series of digital signals a subset of digital signals for displaying an image block selected from the image frame. The subset of digital signals corresponds to a second gray level range based on the first signal—gray level relation. The first gray level range covers the second gray level range. The processing module generates a second signal—gray level relation based on the second gray level range. The processing module then re-displays the image block on the screen based on the subset of digital signals and the second signal—gray level relation. Similarly, according to the image display device of the invention, the image block is re-displayed based on the original digital signals, i.e. the subset of digital signals extracted from the series of the digital signals, and the new signal—gray level relation, i.e. the second signal—gray level relation, so that the re-displayed image block includes plenty of detailed image information. In other words, no matter the image block is re-displayed in the original size or the enlarged size, the re-displayed image block provides more image details than the original image block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an image display device according to an embodiment of the present invention.

FIG. 2 is a flowchart of an image processing method applied in the image display device shown in FIG. 1.

FIG. 3 is a diagram of a first signal—gray level relation according to the embodiment of the present invention.

FIG. 4 is a diagram of a screen of the image display device shown in FIG. 1.

FIG. 5 is a diagram of a second signal—gray level relation according to the embodiment of the present invention.

FIG. 6 is a diagram of an image block re-displayed on the screen shown in FIG. 4.

FIG. 7 is a diagram of the image block re-displayed twice on the screen according to another embodiment of the present invention.

### DETAILED DESCRIPTION

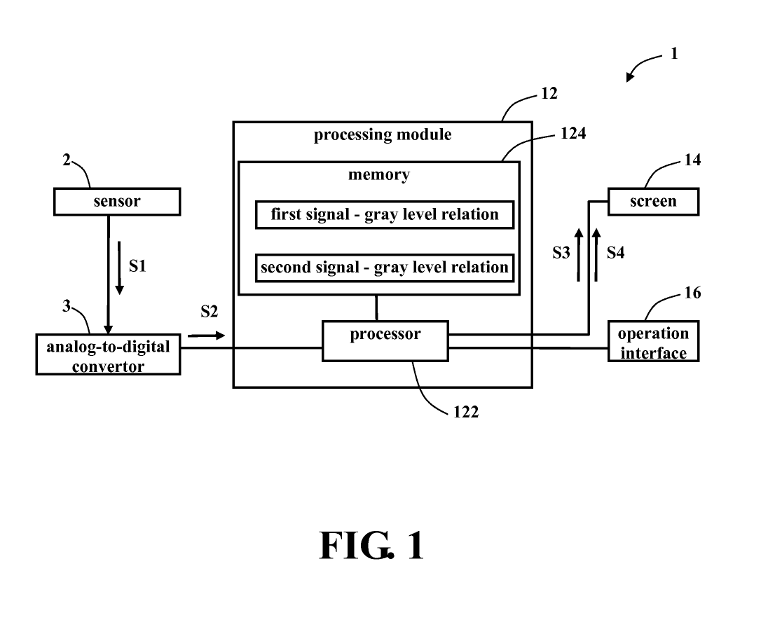

Please refer to FIG. 1. FIG. 1 is a block diagram of an image display device according to an embodiment of the present invention. The Image display device 1 includes a processing module 12, a screen 14 and an operation interface 16. The screen 14 and the operation interface 16 are electrically connected to the processing module 12, respectively. The processing module 12 includes a processor 122 and a memory 124. In the embodiment, a sensor 2 is used to detect an object so as to generate a series of analog signal S1. The series of analog signal S1 is transformed by an analog-to-digital convertor 3 into a series of digital signals S2. The series of digital signals S2 is then received, processed and displayed as an image, such as an ultrasound image, by the image display device 1. The processing module 12 may receive input information from a user through the operation interface 16, accordingly re-process the digital signals S2, and re-display part of the image. In practical application, the analog-to-digital convertor 3 may be integrated into the image display device 1 or into the sensor 2 so as to generate the digital signals S2 directly.

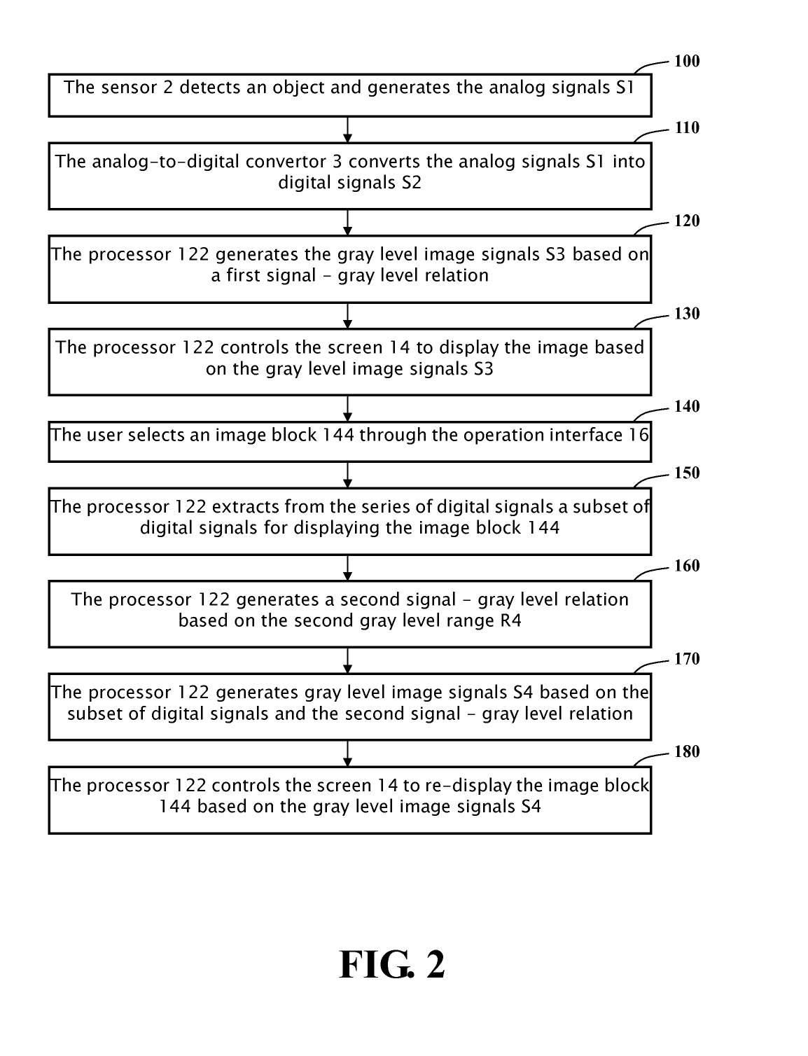

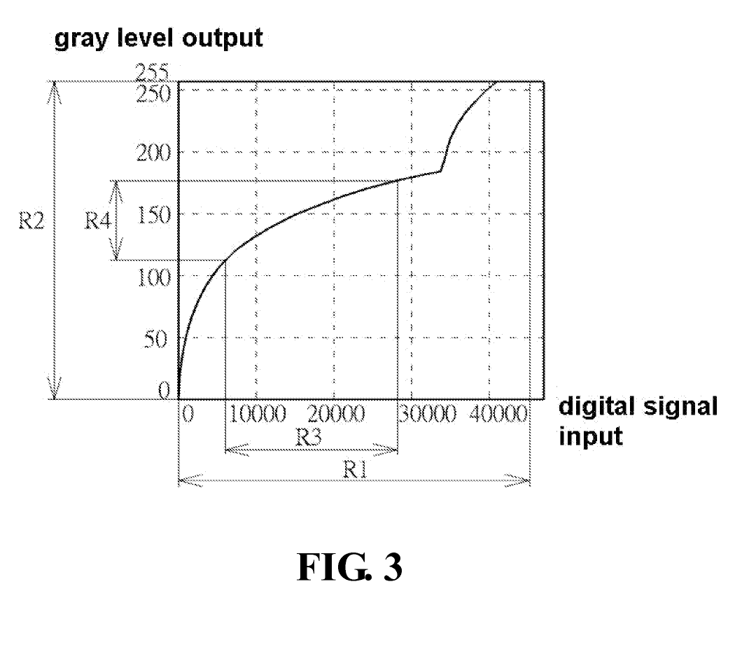

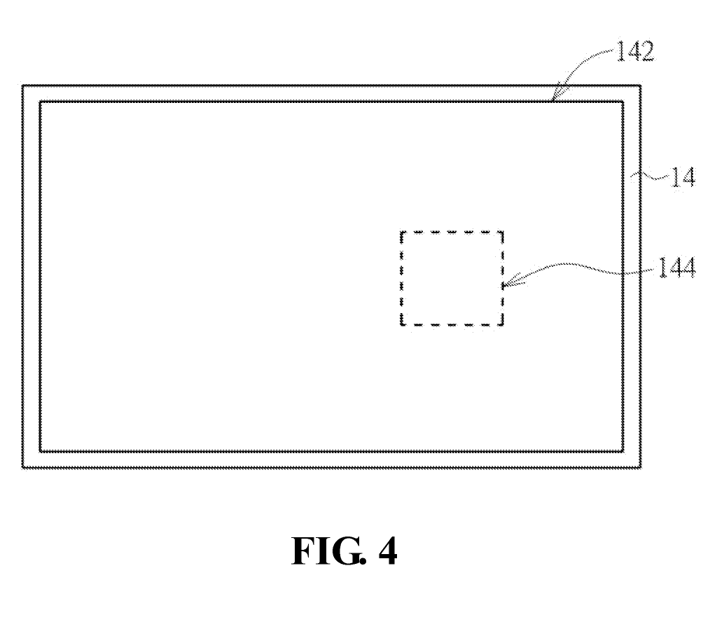

Please also refer to FIG. 2. FIG. 2 is a flowchart of an image processing method applied in the image display device shown in FIG. 1. First of all, the sensor 2 detects the object and generates the analog signals S1, as shown in the step S100. The analog-to-digital convertor 3 then converts the analog signals S1 into digital signals S2, as shown in the step S110. The processor 122 receives the digital signals S2 from the analog-to-digital convertor 3, and generates the gray level image signals S3 based on a first signal—gray level relation shown in FIG. 3, as shown in the step S120. In the first signal—gray level relation, the X axis represents the digital signal input whose unit is the signal strength, and the Y axis represents the gray level output, which is a gray level number between 0 and 255 as an example. The processor 122 then controls the screen 14 to display the image based on the gray level image signals S3, as shown in the step S130. The image forms an image frame 142, as shown in FIG. 4. Generally speaking, the first signal-fray level relation includes at least a digital signal log compression relation, so that both the resolution of the display device and the visual characteristics of the human eyes are taken into consideration. The first signal—gray level relation may be set based on the specification of the sensor 2, and be stored in the memory 124 in advance. In FIG. 3, two digital signal log compression relations shown by two curves are included as an example. At this time, the image frame 142 can provide rough delineation of the characteristics of the object structure.

When the user needs to further review a specific region within the image frame 142, the user selects an image block 144, shown via the frame in dotted lines in FIG. 4, through the operation interface 16, as shown in the step S140. The image block 144 represents the user's region of interest. The operation interface 16 may be an input device, such as a mouse or a touch panel, etc. At this time, the processor 122 receives the input data through the operation interface 16 so as to confirm related information of the image block 144, and to extract from the series of digital signals a subset of digital signals for displaying the image block 144, as shown in the step S150. In practical application, the image frame 142 is normally obtained through scanning the object via an input device, such as the probe of the ultrasound image system, so the corresponding signals among the digital signals can be found out based on the position of the image block 144 relative to the image frame 142. These corresponding signals then form the subset of the digital signals. The aforementioned implementation is well known by those skilled in the art and is therefore not described in details.

Since the subset of digital signals are part of the digital signals S2, under most circumstances, the signal strength of the subset of digital signals and the gray level of the subset of digital signals mapped through the first signal—gray level relation fall within the signal strength range of the digital signals S2 and the gray level range of the digital signals S2 mapped through the first signal—gray level relation, respectively. As shown in FIG. 3, to simplify the explanation for the embodiment, the signal strength range R1 of the digital signals S2 happens to fully correspond to the digital signal input range of the first signal—gray level relation, and the first gray level range R2 corresponding to the digital signals S2 based on the first signal—gray level relation happens to fully correspond to the whole gray level range, i.e. from 0 to 255. The signal strength range R3 of the subset of digital signals falls within the signal strength range R1, and a second gray level range R4 corresponding to the subset of digital signals based on the first signal—gray level relation falls within the first gray level range R2, i.e. the first gray level range R2 covers the second gray level range R4.

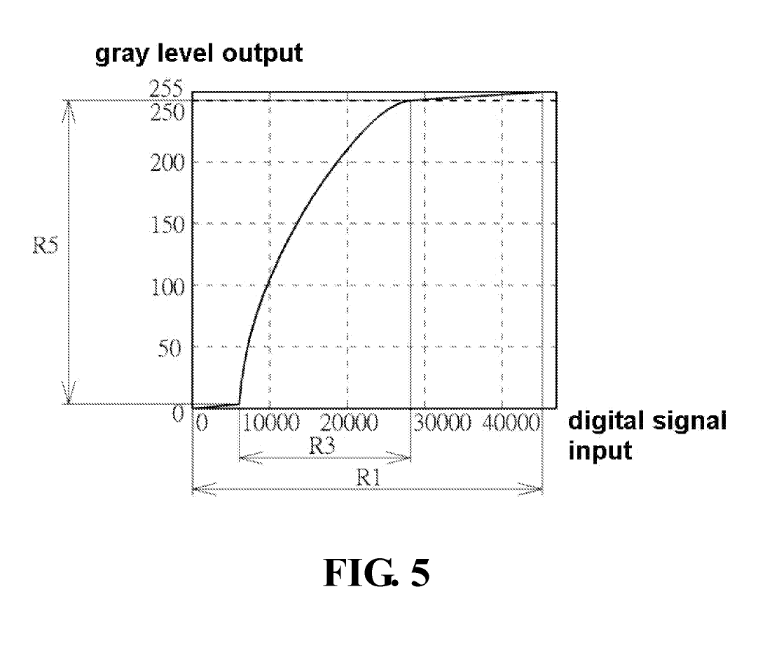

Obviously, the second gray level range R4 is not formed through good use of the whole useable gray level range. The processor 122 therefore generates a second signal—gray level relation based on the second gray level range R4, as shown in the step S160. The second signal—gray level relation is shown in FIG. 5. The subset of digital signals correspond to a third gray level range R5 based on the second signal—gray level relation, and the third gray level range R5 covers the second gray level range R4. In this embodiment, the third gray level range R5 covers substantially the range from 5 to 250, which excludes the gray level range not sensitive to the human eyes, but the invention is not so limited. Under the same consideration, in the first signal—gray level relation, the first signal—gray level relation may be modified so that the first gray level range R2 covers the range from 5 to 250. Besides, in practical application, the third gray level range R5 may be set the same as the first gray level range R2. We would like to additionally explained that in the embodiment the second signal—gray level relation includes a digital signal log compression relation, i.e. the curve of the signal strength range R3 corresponding to the subset of digital signals shown in FIG. 5 may be represented by the function of y=a+b log(x−m), wherein y is the gray level output, x is the digital signal input, and all of a, b, and m are non-negative real numbers. In practical application, the second signal-fray level relation may include several log compression relations, similar to the circumstances of the first signal—gray level relation.

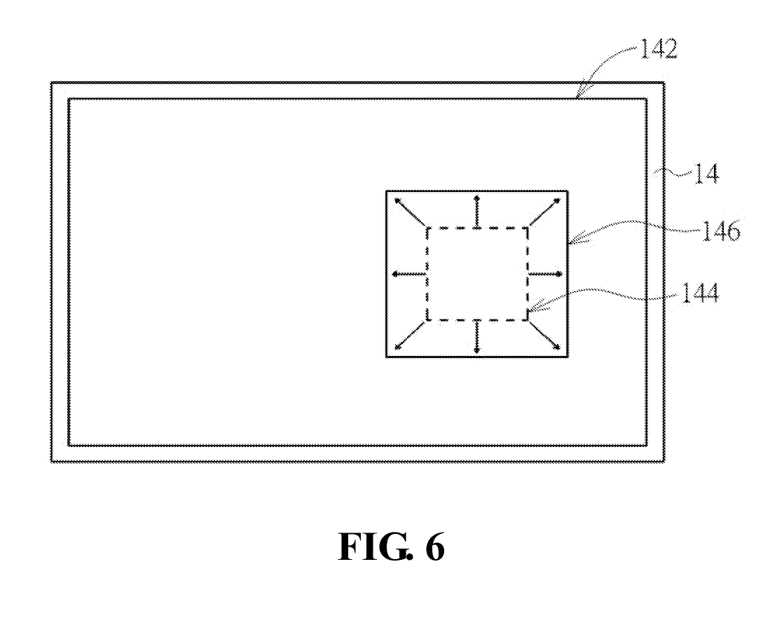

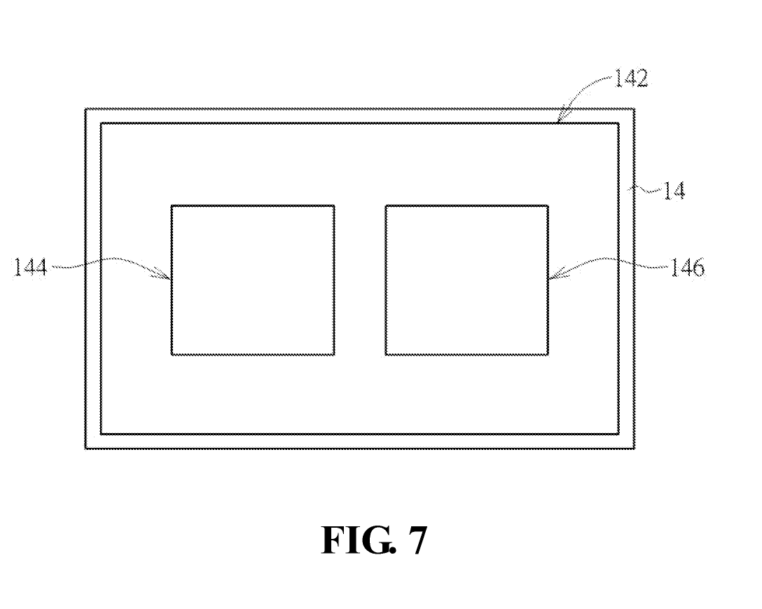

Then, the processor 122 further generates gray level image signals S4 based on the subset of digital signals and the second signal—gray level relation, as shown in the step S170. The processor 122 controls the screen 14 to re-display the image block 144 based on the gray level image signals S4, as shown in the step S180. In one embodiment, the re-displayed image block 146 is re-displayed in the original position with the same size as the original image block 144, and the image frame 142 other than the image block 144 is re-displayed in black, white or kept unchanged. In another embodiment, the re-displayed image block 146 is an enlarged image as shown in FIG. 6, in which the outline of the original image block 144 is shown by dotted lines. In practical application, the re-displayed image block 146 is enlarged to the whole screen 14. In another embodiment, the processor 122 not only re-displays the image block 146 based on the subset of digital signals and the second signal—gray level relation, but also re-display the image block 144 based on the subset of digital signals and the first signal—gray level relation. That is, the re-display image block 146 and the original image block 144 are both displayed in the screen 14 for the user's comparison, as shown in FIG. 7. Moreover, aforementioned image blocks 144 and 146 which are displayed at the same time may be disposed in the upper side and the lower side of the screen 14, respectively, in the left side and the right side of the screen 14, respectively, or disposed in the screen 14 in other way at the same time. The image blocks 144 and 146 are not limited to the same size.

The prior art merely increases the contrast for the original gray level image signals to sharpen the image, but is not able to provide image details not included in the original gray level image signals. On the contrary, based on the image processing method of the invention, the gray level signals S3 and S4 mapped by the subset of digital signals based on the first and the second signal—gray relations, respectively, are different. Since the gray level range of the gray level signals S4 is obviously larger than that of the gray level image signals S3, the contrast of the image block 146 is better than that of the image block 144 and the gray level image signals S4 shows more characteristics of the subset of digital signals than the gray level image signals S3 does. Therefore, compared with the image block 144, the image block 146 re-displayed based on the gray level image signals S4 covers more gray level resolution and therefore includes more image detail information. Since more clear image is provided, the problems of the prior art is resolved.

Those skilled in the art will readily observe that numerous modifications and alterations of the device and method may be made while retaining the teachings of the invention.

What is claimed is:

1. An image processing method for re-displaying an image block selected from an image frame, the image frame being displayed based on a series of digital signals and a first signal - gray level relation, the image processing method comprising:
Extracting a subset of digital signals for displaying the image block from the series of digital signals, wherein based on the first signal—gray level relation the series of digital signals and the subset of digital signals correspond to a first and a second gray level ranges, respectively;
generating a second signal—gray level relation based on the second gray level range; and
re-displaying the image block based on the subset of digital signals and the second signal—gray level relation.

2. The image processing method of claim 1, wherein the first signal—gray level relation and the second signal—fray level relation comprise a digital signal log compression relation, respectively.

3. The image processing method of claim 1, wherein the second signal—gray level relation is presented in a function of y=a+blog(x−m), y is the gray level, x is the digital signal, and all of a, b, and m are non-negative real numbers.

4. The image processing method of claim 1, wherein the subset of digital signals corresponds to a third gray level range based on the second signal—gray level relation, and the third gray level range covers the second gray level range.

5. The image processing method of claim 4, wherein the third gray level range and the first gray level range are the same.

6. The image processing method of claim 1, wherein the image block is enlarged and re-displayed based on the subset of digital signals and the second signal—gray level relation.

7. The image processing method of claim 1, further comprising:
Re-displaying the image frame other than the image block in white or black.

8. The image processing method of claim 1, wherein the re-displaying step comprising:
Displaying the image block twice based on the subset of digital signals and based on the first signal—gray level relation and the second signal—gray level relation, respectively.

9. An image display device comprising:
A screen; and
A processing module electrically connected to the screen, wherein the processing module receives a series of digital signals and displays an image frame on the screen based on a first signal—gray level relation, the series of digital signals corresponds to a first gray level range based on the first signal—gray level relation, the processing module extracts from the series of digital signals a subset of digital signals for displaying an image block selected from the image frame, the subset of digital signals corresponds to a second gray level range based on the first signal—gray level relation, the first gray level range covers the second gray level range, the processing module generates a second signal—gray level relation based on the second gray level range, and the processing module re-displays the image block on the screen based on the subset of digital signals and the second signal—gray level relation.

10. The image display device of claim 9, wherein the first signal—gray level relation and the second signal—fray level relation comprise a digital signal log compression relation, respectively.

11. The image display device of claim 9, wherein the second signal—gray level relation is presented in a function of y=a+b log(x−m), y is the gray level, x is the digital signal, and all of a, b, and m are non-negative real numbers.

12. The image display device of claim 9, wherein the subset of digital signals corresponds to a third gray level range based on the second signal—gray level relation, and the third gray level range covers the second gray level range.

13. The image display device of claim 12, wherein the third gray level range and the first gray level range are the same.

14. The image display device of claim 9, wherein the processing module re-displays the enlarged image block on the screen based on the subset of digital signals and the second signal—gray level relation.

15. The image display device of claim 9, wherein the processing module re-displays the image frame other than the image block in white or black.

16. The image display device of claim 9, wherein the processing module re-displays the image block twice on the screen based on the subset of digital signals and based on the first signal—gray level relation and the second signal—gray level relation, respectively.
